(19) United States
(12) Patent Application Publication
(10) Pub. No.: US 2008/0297740 A1
(43) Pub. Date: Dec. 4, 2008

(54) Projection system and method of use thereof

(76) Inventors: Phong Huynh, Fayetteville, GA (US); Liem Huynh, Fayetteville, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/807,511

(22) Filed: May 29, 2007

(51) Int. Cl. G03B 21/14

(52) U.S. Cl. 353/94; 353/121; 353/122

(57) ABSTRACT

A projection system and method of use thereof, wherein a computer in electrical communication with at least one projector projects a layout, preferably onto a floor projection surface utilizing short throw lenses, wherein the layout preferably comprises a grid and indicia relating to an exhibitor.

### FIELD OF INVENTION

The present invention relates to projection systems and method of use thereof, and more particularly to a system for projecting a grid onto a floor via short throw lenses with at least one projector in communication with a computing apparatus.

### BACKGROUND ART

Projectors are fairly well known in today's society. Projectors are utilized at movie theatres and sometimes in homes for television viewing, but particularly, projectors and computers are utilized in combination everyday in offices for various types of presentations.

One existing device discloses utilizing a single projector to display a pattern on a patient for performing surgery. Another device discloses utilizing a single projector to display a grid on a work space to assure alignment of articles for graphic arts. Further, projectors are typically utilized individually and do not lend themselves to the use of multiple projectors with overlapping projection fields without causing distortion or discoloring.

Few of the projectors utilized in practice are used to project onto something other than a screen or wall due to the nature of the subject matter being projected. Further, projectors are particularly sensitive in terms of the distance they must be from the surface to be projected onto, and variations in that distance can lead to distortion or bad picture quality.

Conventions or trade shows are often held in large rooms where multiple exhibitors are typically responsible for setting up their own tables, booths, or displays. Sometimes, rules require the use of non-exhibiting personnel to set up booths. Either of these requires guidance as to the limits of the booth space. Further, such limits are often pre-marked by convention staff.

In order to so mark the booth limits, spaces for each exhibitor are typically marked off with tape, and utilize numbers and/or names, wherein each exhibitor is given a map to its location where they may subsequently set up their exhibits. After the convention is over, the tape typically has to be removed and another set of grids laid out in tape for the next convention or trade show utilizing the same area. This requires massive amounts of tape, labor to lay the tape, and labor to pull up the tape. Additionally, it is subject to human error in translating map drawings, measuring booth limits and laying down tape in straight lines.

Further, convention or conference centers are often unable to have multiple events during a short period due to the amount of time necessary to lay the tape and remove it. Additionally, using tape can result in crooked lines causing distortion and inaccuracy in the spaces reserved for the exhibitors. Further, any changes in the layout of the grid become exponentially difficult, as it is difficult to move one exhibitor without affecting the other. Adding one exhibitor to a row would require reducing the space of all exhibitors in the entire row, which would in turn require removing the majority of the tape for the entire row. Thus, the current practice is wasteful in terms of money, labor and time, and restricts alterations and turnaround for events.

Therefore, it is readily apparent that there is a need for a projection system and method which minimizes and/or overcomes these deficiencies by providing a projection system wherein the need for taping off lines is eliminated. This would serve the functions of reducing cost, time, inefficiencies and labor, while providing a higher turnaround time between events and facilitating any alterations in the layout.

### SUMMARY OF THE INVENTION

Briefly described, in a preferred embodiment, the present invention overcomes the above-mentioned disadvantages and meets the recognized need for such a device by providing a projection system and method of use thereof designed to project a grid or layout onto a floor utilizing short throw lenses. Projecting the layout onto the floor eliminates the need for tape, thereby saving time, resources and labor, while increasing accuracy and speed. Short throw lenses broaden the field of projection allowing fewer projectors to cover a larger space.

According to its major aspects and broadly stated, the present invention in a preferred form is a grid projection system and method of use thereof comprising a computing apparatus, a projection surface, and projector mechanisms in communication with the computing apparatus, wherein each of the projector mechanisms projects a selected image onto the projection surface. Having multiple projectors allows the combined images to cover a much larger space than a single projector.

Additionally, the computing apparatus further comprises computer aided drafting software. Computer aided drafting software simplifies the design process of the images to be projected onto the projection surface and facilitates rapid and simple modification of grid patterns.

Further, projector mechanisms are suspended overhead and project the image onto a floor. The present invention is particularly useful to project images from a space above a floor, preferably the ceiling or in the rafters, onto the floor without distortion, thus covering a large amount of space with multiple projectors and eliminating the need to tape a grid pattern on the floor.

The projector mechanisms may comprise short throw lenses for displaying the selected image on the projection surface. Short throw lenses allow the image to be projected at a wider angle across the floor, thus reducing the number of projectors needed. Short throw lenses also reduce the amount of distortion in the projected image.

The projector mechanisms receive the selected image to be displayed from the computing apparatus. The selected image and any necessary data may be sent either wirelessly or through a wired means, both of which technologies are well known in the art. Having wireless access to the projector mechanisms reduces the overall cost of the grid projection system by reducing the amount of material which must be installed and reduces any alteration which may be necessary to run the wires through the installation location.

In a preferred embodiment, the individual images projected by the projector mechanisms may selectively overlap each other and work in combination to form a single combined image projected onto the projection surface. Allowing a single image to be produced from multiple smaller images eliminates the need to perfectly align each of the projector mechanisms and allows coverage of spaces larger than the projection area of a single projector mechanism. Further, it allows the projection area to be reduced, while selectively utilizing one or more of the projector mechanisms, should a grid not need to be projected onto the entire projection area.

In another preferred embodiment, the at least one image is a single image, wherein the single image is parsed into separate images, and wherein the separate images are projected onto the projection surface via the projector mechanisms to reform the single image on the projection surface. Thus a single image is projected from multiple projectors, allowing a single image to cover a projection surface which is limited only by the number of projectors.

In one preferred embodiment, the selected image projected by the projector mechanisms is a grid. The grid may be laid out in any desired design or pattern, but is particularly useful for partitioning areas of the projection surface, such as the floor, wherein any exhibitors in a conference room, convention center, arena, or the like can view their designated partitioned area merely by looking downward at the floor. In a further embodiment, the projector mechanisms may also project indicia within the grid. These indicia may include, but are not limited to a name, number, design, logo or trademark identifying the exhibitor who is designated the area partitioned by the grid.

In a further preferred embodiment, the grid may be generated by a user, designer or operator with the use of computer aided drafting software, reducing the time necessary to design a layout or grid, facilitating any changes in the grid, switching between grid layouts to accommodate subsequent exhibitions, and allowing easier communication of the grid to the projector mechanism. In yet another preferred embodiment, the grid may be automatically generated by the computing apparatus when supplied with certain information, such as for exemplary purposes only and not meant to be limiting, size of the booth for each exhibitor or for all exhibitors together, preference of each exhibitor as to location, and the name, design, logo, trademark, number or other indicia for each exhibitor. Thus given the size of each booth, location preferences and representative indicia, the computing apparatus can generate the most efficient grid and layout without the need for human attention or interaction.

In still another preferred embodiment, multiple images or grids are stored on a computing apparatus readable format and a user may select which grid or image to display on the projection surface, enabling a rapid transition from a first displayed image or grid to a second displayed image or grid projected onto the projection surface. Thus a user can variably select which grid or image to be projected by the projector mechanisms, allowing rapid switching between grid layouts to meet the needs of subsequent exhibitor groups.

In a preferred use, a layout, image, or grid is either loaded into or developed on a computer, wherein the layout comprises a plurality of dividing lines. Once in the computer, the layout is relayed to at least one projector, wherein the layout is projected onto a floor via at least one projector. Thus a method for displaying a layout on a floor is disclosed, wherein the method reduces cost, time, labor and materials. In a further use, the layout is projected through a short throw lens, which reduces the number of projectors necessary and reduces distortion.

In a preferred embodiment a system for projecting a grid comprises a computer, wherein the computer comprises computer aided drafting software, a layout digitally stored within the computer, a floor, and at least one projector in communication with the computer, wherein the at least one projector projects the layout onto the floor via a short throw lens.

More specifically, the present invention is a projection system and method of use thereof, wherein at least one projector in electrical communication with a computer projects a layout onto a floor. The projector preferably utilizes short throw lenses to reduce distortion. The computer is preferably in wireless communication with the projectors, wherein the wireless communication may be received by a wireless receptor on the projectors. Alternatively, the computer may be in electrical communication with the projectors via a wired connection. The wired connection from the computer to the plurality of projectors may run in serial or parallel. In a preferred embodiment, the first projector preferably projects a first projection field onto the floor. The second projector projects onto the floor in a second projection field, while the third projector projects into a third projection field, the three selected images combining to form the layout. The first projection field and the third projection field may overlap with the second projection field. Each projector of the plurality of projectors may also preferably project identifying indicia which may comprise names, numbers, logos, trademarks, designs, or other indicia.

Accordingly, a feature and advantage of the present invention is its ability to reduce the amount of labor when laying out a grid system on a floor by providing the grid system through at least one projector.

Another feature and advantage of the present invention is its ability to display a single image using multiple projectors, even where there is overlap between the individual images.

Still another feature and advantage of the present invention is its ability to reduce the amount of time it takes to lay out and remove a grid system on a floor by eliminating the need for taping or non-digitally marking the floor.

Yet another feature and advantage of the present invention is its ability to save money by reducing the amount of supplies necessary to display a grid on a floor.

Yet still another feature and advantage of the present invention is its ability to reduce the amount of time required to display a grid system on a floor thereby allowing a quicker turnaround time between functions.

A further feature and advantage of the present invention is its ability to provide a system which allows for easy changes in design of a grid system displayed on a floor.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to the elements throughout, and in which:

FIG. 1 shows a top view of a preferred embodiment;

FIG. 2 shows a side view of a preferred embodiment; and

FIG. 3 shows a perspective view of a preferred embodiment.

### DETAILED DESCRIPTION OF THE PREFERRED AND SELECTED ALTERNATE EMBODIMENTS

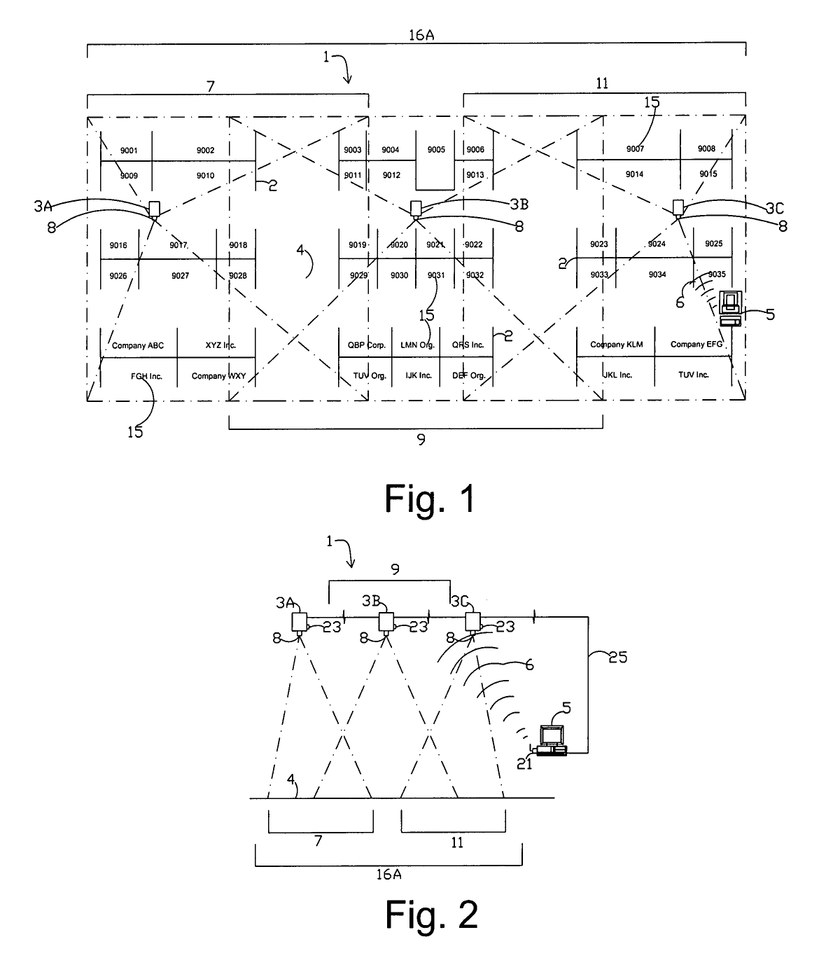

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in a preferred embodiment comprises projection system 1, wherein at least one projector mechanism 3 in electrical communication with computer 5 projects layout 16 onto floor 4. At least one projector mechanism 3 preferably utilizes short throw lens 8 to reduce distortion and increase area of projection fields 7, 9, and 11 projected onto floor 4. Layout 16 preferably comprises grid lines 2 and indicia 15, wherein grid lines 2 identify the area for individual exhibitors to set up, and wherein indicia 15 identify which exhibitor is in each allotted space.

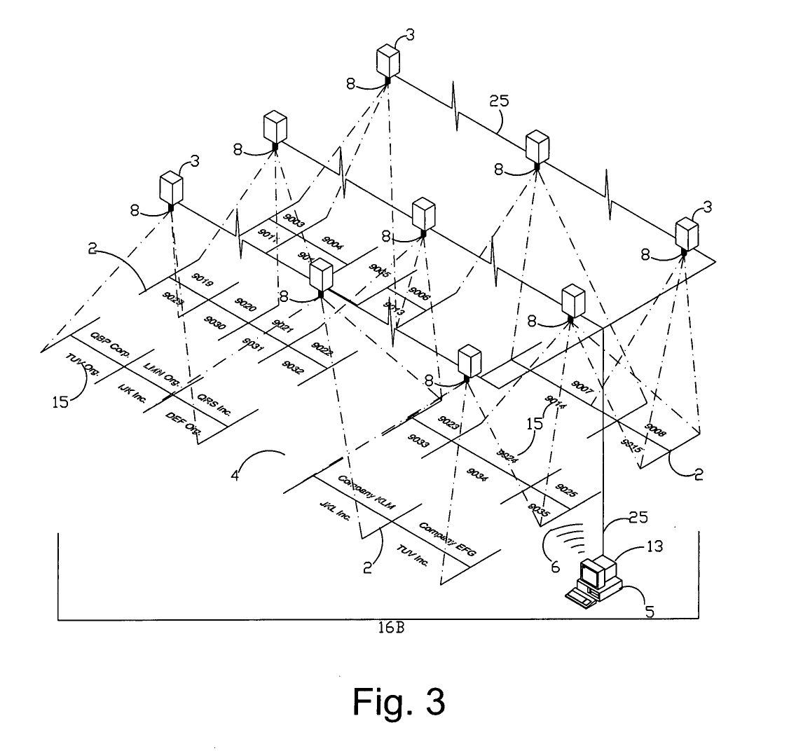

Still referring to FIGS. 1-3, computer 5 is preferably in wireless communication 6 with at least one projector mechanism 3, wherein wireless communication 6 is transmitted by wireless transmitter 21 on computer 5 and received by wireless receptor 23 of projector mechanism 3. Alternatively, computer 5 is in electrical communication with projector mechanism 3 via wired connection 25 (best shown in FIGS. 2 and 3). Wired connection 25 from computer 5 to at least one projector mechanism 3 selectively runs in serial or parallel.

As shown in FIGS. 1 and 2, in a preferred embodiment, first projector mechanism 3a preferably projects first projection field 7 onto floor 4. Second projector mechanism 3b preferably projects onto floor 4 in second projection field 9 while third projector mechanism 3c preferably projects into third projection field 11, wherein projection fields, 7, 9 and 11 form layout 16. First projection field 7 and third projection field 11 may selectively overlap with second projection field 9, wherein projection fields 7, 9, and 11 preferably overlap substantially to produce layout 16 which is more defined and easier for exhibitors or setup personnel to read. Alternatively, projection fields 7, 9, and 11 may have minimal or no overlap to ensure a minimum number of projector mechanisms 3 are utilized to display layout 16, but. Each projector mechanism 3a, 3b, 3c of plurality of projectors 3 may also preferably project indicia 15 which may comprise names, numbers, logos, designs, trademarks or other indicia.

As shown in FIGS. 1-3, when in use, computer 5 preferably runs computer aided drafting software 13 to facilitate drafting grid lines 2 and indicia 15 to form layout 16. Alternatively, layouts 16 can be uploaded to computer 5 in any known format suitable for electronic transmission to projector mechanisms 3. Once layout 16 is stored in machine-readable format on computer 5, layout 16 is parsed into selected images which are in turn transmitted to their respective projector mechanism 3 via wired means 25 or wireless communication 6 (best shown in FIGS. 1 and 3). Each projector mechanism 3a, 3b, and 3c then projects respective selected images as respective projection fields 7, 9 and 11 onto floor 4 (best shown in FIGS. 1 and 2). Thus layout 16, whether designed in computer 5 or uploaded to computer 5 is transmitted to projector mechanisms 3 and displayed on floor 4.

In a preferred embodiment, as shown in FIGS. 1-3, operator of projection system 1 preferably selects which layout 16 to be displayed on floor 4 by projector mechanism 3 and loads layout 16 into computer 5. Alternatively, multiple layouts 16, comprised of grid lines 2 and/or indicia 15, are stored on computer 5 in readable format and operator selects which layout 16a or 16b to load and display on projection surface or floor 4. This enables rapid transition from projection of first layout 16a to second layout 16b thus saving time, money, and labor while increasing efficiency. Upon entry, exhibitors can readily determine their assigned location via indicia 15 by looking at floor 4, and can assemble within their assigned grid lines 2.

In use, layout 16 is projected onto floor 4, wherein projecting layout 16 comprises loading layout 16 into computer 5, wherein layout 16 comprises grid lines 2, relaying layout 16 to at least one projector mechanism 3, and projecting layout 16 onto floor 4 via projector mechanism 16. In a further use, projector mechanism 3 further comprises short thrown lenses 8 and layout 16 is projected via short throw lenses 8. In still a further use, projector mechanism 3 also projects grid lines 2 with indicia 15 to form layout 16.

The foregoing description and drawings comprise illustrative embodiments of the present invention. Having thus described exemplary embodiments of the present invention, it should be noted by those skilled in the art that the embodiments within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A grid projection system comprising:
a computing apparatus;
a projection surface; and
at least one projector mechanism in communication with said computing apparatus, wherein each of said at least one projector mechanisms projects at least one image onto said projection surface.

2. The apparatus of claim 1, wherein said computing apparatus further comprises computer aided drafting software.

3. The apparatus of claim 1, wherein said at least one image is designed via said computing apparatus.

4. The apparatus of claim 1, wherein said projection surface is a floor.

5. The apparatus of claim 1, wherein said at least one projector mechanisms further comprises a short throw lens for projecting onto said projection surface.

6. The apparatus of claim 1, wherein said at least one projector mechanisms is in communication with said computing apparatus via wires.

7. The apparatus of claim 1, wherein said at least one projector mechanisms is in communication with said computing apparatus via wireless communication.

8. The apparatus of claim 1, wherein said at least one image projected by said at least one projector mechanism overlaps with at least one other of said at least one image projected by said at least one projector mechanisms.

9. The apparatus of claim 1, wherein said at least one image is a single image, wherein said single image is parsed into separate images, and wherein said separate images are projected onto said projection surface via said at least one projector mechanism to reform said single image on said projection surface.

10. The apparatus of claim 1, wherein said at least one image is a grid projected by said at least one projector mechanisms onto said projection surface.

11. The apparatus of claim 1, wherein said at least one image is generated via said computing apparatus.

12. The apparatus of claim 10, wherein said grid comprises a plurality of indicia.

13. The apparatus of claim 12, wherein at least one of said plurality indicia comprises a name.

14. The apparatus of claim 12, wherein at least one of said plurality of indicia comprises a number.

15. The apparatus of claim 10, wherein said grid is variably selected from a plurality of available grids.

16. The apparatus of claim 10, wherein said grid is designed by a user with said computer aided drafting software.

17. A method for projecting an image onto a surface, said method comprising the steps of:
loading a layout into a computer, wherein said layout comprises a plurality of dividing lines;
relaying said layout to at least one projector; and
projecting said layout onto a floor via said at least one projector.

18. The method of claim 17, wherein said projecting step further comprises the step of:
projecting said layout through a short throw lens.

19. The method of claim 17, wherein said projecting step further comprises the step of:
projecting a grid and at least one indicia along with said layout.

20. A system for projecting a grid comprising:
a computer, wherein said computer comprises computer aided drafting software;
a layout digitally stored within said computer;
a floor; and
at least one projector in communication with said computer, wherein said at least one projector projects said layout onto said floor via a short throw lens.
